(19) United States
(12) Patent Application Publication
(10) Pub. No.: US 2026/0106314 A1
(43) Pub. Date: Apr. 16, 2026

(54) VENTING SYSTEM FOR TRACTION BATTERY PACK

(71) Applicant: Ford Global Technologies, LLC, Dearborn, MI (US)

(72) Inventors: Xiaogang Zhang, Novi, MI (US); Steven Wooldridge, Manchester, MI (US)

(21) Appl. No.: 18/914,451

(22) Filed: Oct. 14, 2024

(51) Int. Cl. H01M 50/367; H01M 10/6567; H01M 50/213; H01M 50/249

(52) U.S. Cl. CPC H01M 50/367; H01M 10/6567; H01M 50/213; H01M 50/249

(57) ABSTRACT

A traction battery pack venting system includes a first group of battery cells, a second group of battery cells, and a vent chamber sandwiched between a first group of battery cells and the second group of battery cells. The first group of battery cells and the second group of battery cells are each configured to vent to the vent chamber.

### TECHNICAL FIELD

This disclosure relates generally to a venting system for a battery pack and, more particularly, to a venting system for a battery pack having an immersion-based thermal management system.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack venting system, including: a first group of battery cells; a second group of battery cells; and a vent chamber sandwiched between a first group of battery cells and the second group of battery cells, the first group of battery cells and the second group of battery cells each configured to vent to the vent chamber.

In some aspects, the techniques described herein relate to a venting system, wherein the first group of battery cells and the second group of battery cells are immersed in a liquid.

In some aspects, the techniques described herein relate to a venting system, wherein the first group of battery cells and the second group of battery cells are immersion cooled.

In some aspects, the techniques described herein relate to a venting system, wherein the first group of battery cells and the second group of battery cells are cylindrical battery cells.

In some aspects, the techniques described herein relate to a venting system, wherein the first group of battery cells is inverted relative to the second group of battery cells.

In some aspects, the techniques described herein relate to a venting system, wherein the vent chamber is sealed from a first housing that encloses the first group of battery cells, and from a second housing that encloses the second group of battery cells such that liquid communicated through the first housing and the second housing as part of an immersion thermal management system is blocked from entering the vent chamber.

In some aspects, the techniques described herein relate to a venting system, wherein the battery cells in the first group of battery cells and within the second group of battery cells are each disposed along a respective battery cell axis, wherein each of the battery cell axes of the battery cells within the first group is offset from each of the battery cell axes of the battery cells within the second group.

In some aspects, the techniques described herein relate to a venting system, further including a thermal management system having a liquid, the thermal management system configured to circulate the liquid between a first housing that encloses the first group of battery cells and through a second housing that encloses the second group of battery cells without the liquid passing through the vent chamber.

In some aspects, the techniques described herein relate to a venting system, wherein the first group of battery cells and the second group of battery cells are at least partially immersed within the liquid.

In some aspects, the techniques described herein relate to a venting system, further including a plurality of cell holders, the cell holders each configured to hold one of the battery cells within the first group of battery cells or one of the battery cells within the second group of battery cells.

In some aspects, the techniques described herein relate to a venting system, wherein the cell holders are annular.

In some aspects, the techniques described herein relate to a venting system, wherein the cell holders include a sealing ring configured to seal an interface between the respective cell holder and the respective battery cell.

In some aspects, the techniques described herein relate to a venting system, wherein the cell holders extend from a side of the vent chamber.

In some aspects, the techniques described herein relate to a venting system, wherein the first group of battery cells and the second group of battery cells are each configured to vent through a respective floor of a cell holder to the vent chamber.

In some aspects, the techniques described herein relate to a venting system, further including a plurality of pins that interface with an end portion of a respective battery cell to hold a position of the respective battery cell.

In some aspects, the techniques described herein relate to a venting system, wherein the pins are configured to hold the respective battery cell at a position spaced from an adjacent battery cells to provide a path for a liquid to flow.

In some aspects, the techniques described herein relate to a traction battery pack venting system, including: a vent chamber of a battery pack; a first housing of the battery pack, the first housing enclosing a first group of battery cells that are configured to vent into the vent chamber through a first side of the vent chamber; a second housing of the battery pack, the second housing enclosing a second group of battery cells that are configured to vent into the vent chamber through a different second side of the vent chamber; and a thermal management system having a liquid, the thermal management system configured to circulate the liquid through the first housing and the second housing.

In some aspects, the techniques described herein relate to a venting system, wherein the first side is opposite the second side.

In some aspects, the techniques described herein relate to a venting system, wherein the thermal management system circulates the liquid through the battery pack without the liquid passing through the vent chamber.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of a battery cell from the battery pack of FIG. 1.

FIG. 3 illustrates another perspective view of the battery cell of FIG. 2.

FIG. 4 illustrates a perspective view of the battery pack from the electrified vehicle of FIG. 1.

FIG. 5 illustrates the battery pack of FIG. 4 with selected portions removed to show a first group and a second group of battery cells interfacing with a venting chamber of the battery pack.

FIG. 6 illustrates a close-up view of an area of FIG. 5.

FIG. 7 illustrates a close-up view of an area of FIG. 5 with the battery cells removed.

FIG. 8 illustrates a section view taken at line 8–8 in FIG. 6.

FIG. 9 illustrates a highly schematic view of an immersion-based thermal management system used in connection with the battery pack, which is also shown schematically .

FIG. 10 illustrates a side view of the venting chamber of FIG. 5 showing the locations of the cells with broken lines and showing how the vent chamber openings on a first side of the venting chamber are offset from the vent chamber openings on an opposite, second side of the venting chamber.

### DETAILED DESCRIPTION

This disclosure details exemplary traction battery packs with venting systems and an immersion-based thermal management systems. The venting systems can include a vent chamber. The groups of battery cells can vent into the vent chamber. A liquid, such as a dielectric liquid, can circulate over battery cells without moving into the vent chamber. The liquid can help to manage thermal energy in at least the battery cells. The vent chamber can be sealed from the liquid.

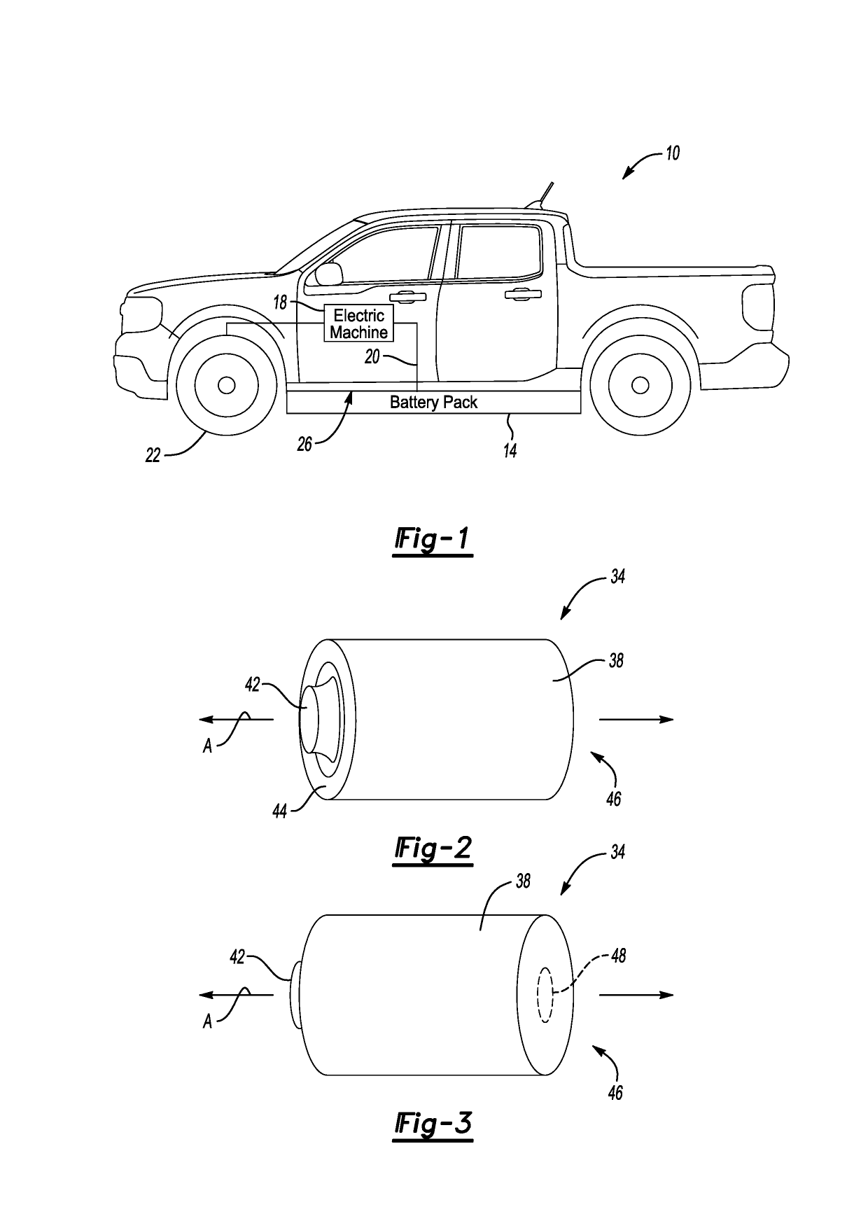

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

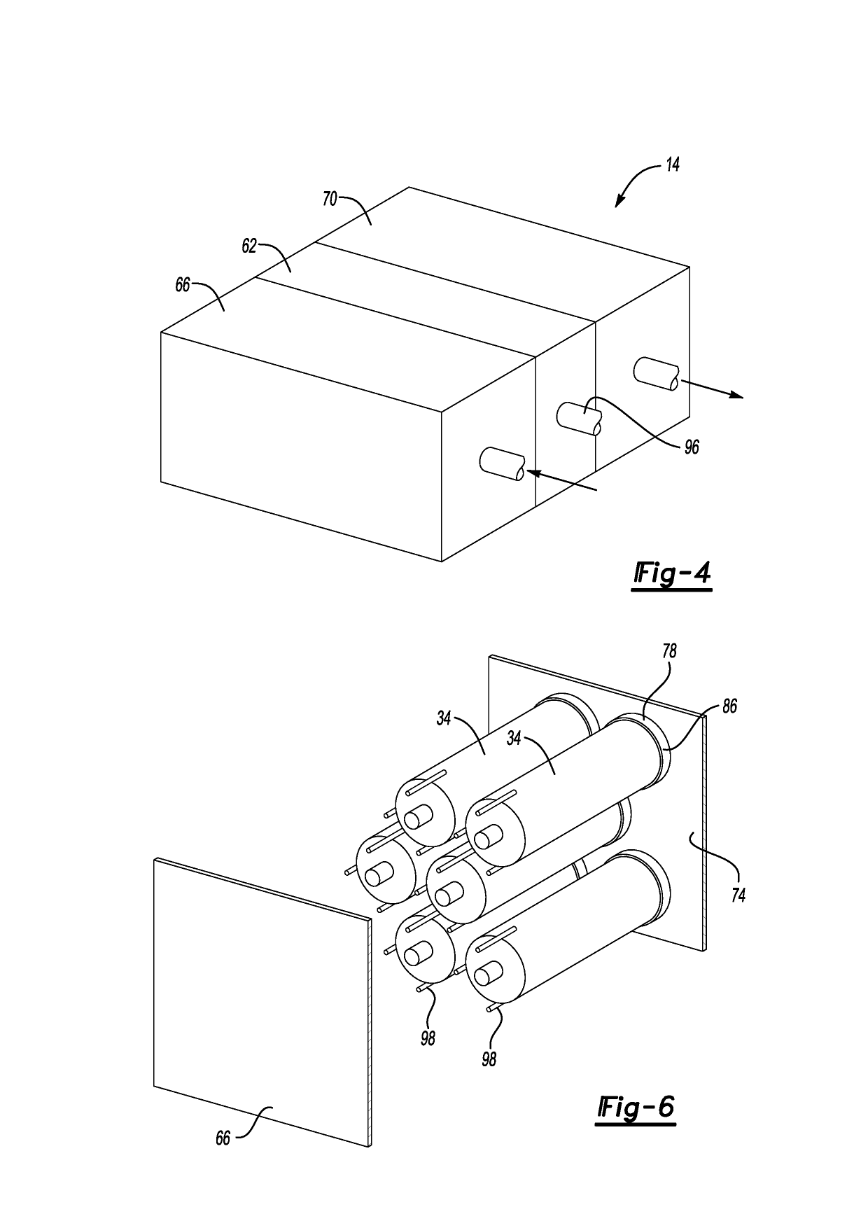

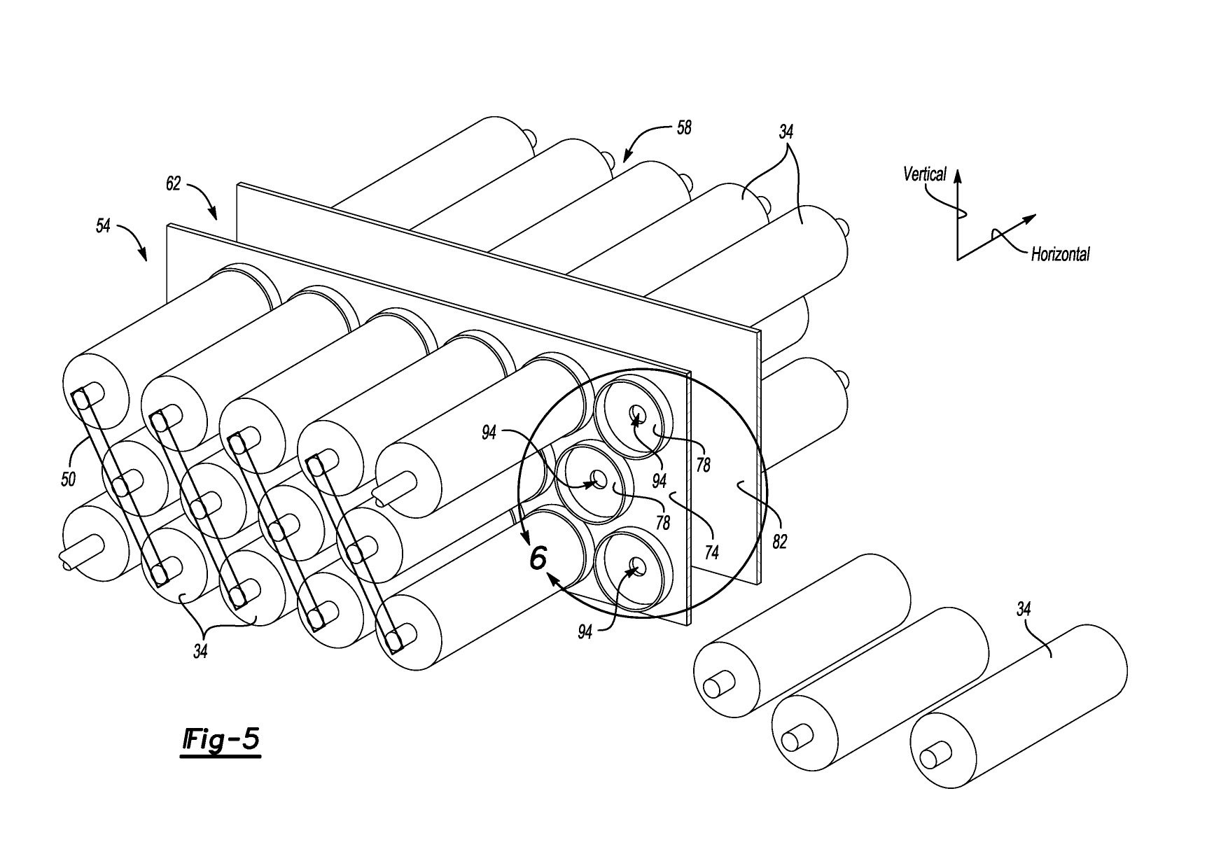

With reference now to FIGS. 2-5, the battery pack of the exemplary embodiment includes a plurality of battery cells 34. The battery cells 34 are cylindrical battery cells in this example. In particular, the example battery cells 34 each have a jellyroll-style electrode structure housed within an case 38. The cylindrical battery cells 34 are each disposed along a respective battery cell axis A.

A cap 42 of the case 38 provides a positive terminal at a first axial end of each cell 34. The cap 42 is raised above an ring 44, which provides a negative terminal at the first axial end of each cell 34. A venting side 46 of the case 38 is located at an opposite, second axial end of each cell 34. A venting passage 48 extends through the venting side 46. Should a thermal event lead to one of the cells 34 venting, the venting passage 48 can provide a path for expelling vent byproducts from that one of the cells 34. The venting passage 48 can be covered – by a membrane, for example – until the cell 34 begins to vent. The increased pressure within one of the cells 34 can rupture the membrane to allow vent byproducts to pass through the venting passage 48.

Busbars 50 can connect to the terminals provided by the caps 42 and rings 44 of the cells 34 to electrically couple the cells 34 to other cells 34, to other components of the battery pack 14, or both.

The battery cells 34 of the example battery pack 14 are separated into a first group 54 of battery cells 34 and a second group 58 of battery cells 34. Sandwiched between the first group 54 and the second group 58 is a vent chamber 62.

The first group 54 of battery cells 34 is enclosed within a first housing 66. The second group 58 of battery cells 34 is enclosed within a second housing 70. The vent chamber 62 is sealed from the first housing 66 and the second housing 70.

In this example, the first group 54 and the second group 58 are arranged on either side of the vent chamber 62. The cells 34 of the first group 54 and the cells 34 of the second group 58 are disposed horizontally with the sides 46 interfacing with the vent chamber 62. Horizontal, for purposes of this disclosure is with reference to ground and general orientation of the battery pack 14 when installed within the vehicle.

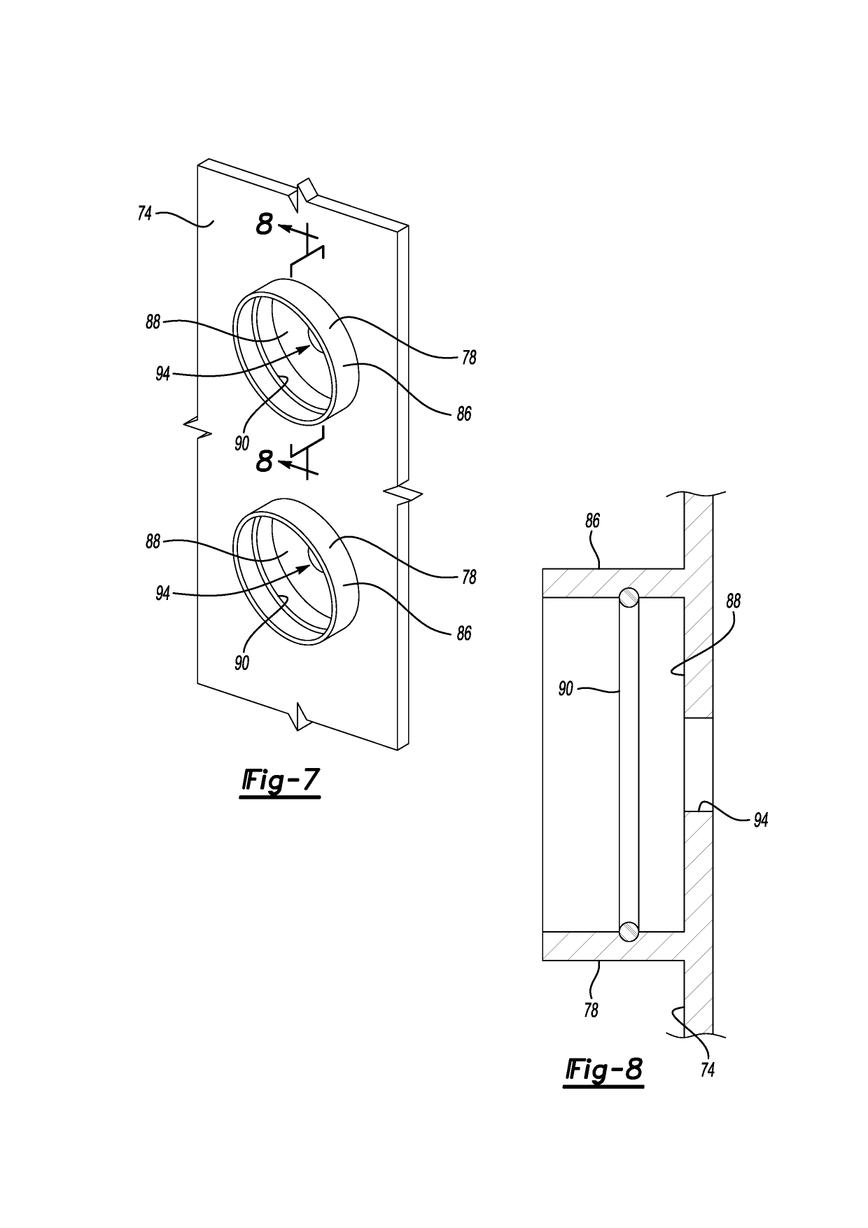

With reference now to FIGS. 6-8 and continuing reference to FIGS. 2-5, a first side 74 of the vent chamber 62 includes a plurality of cell holders 78. The battery cells 34 of the first group 54 each fit within one of the cell holders 78 disposed on the first side 74. An opposite, second side 82 of the vent chamber 62 includes an additional plurality of cell holders 78. The battery cells 34 within the second group 58 each fit within one of the cell holders 78 disposed on the second side 82 of the vent chamber 62. The first group 54 of battery cells 34 and the second group 58 of battery cells 34 are inverted relative to each other. That is, the caps 42 of the cells 34 in the first group 54 face outward from the vent chamber 62 in first direction, and the caps 42 of the cells in the second group 58 face outward from the vent chamber 62 in an opposite, second direction.

Each of the cell holders 78, in this example, include a collar 86, a floor 88, and a sealing ring 90. The collar 86 is raised away from a wall of the vent chamber 62. The collar 86 is annular. The collar 86 receives a portion of a respective one of the battery cells 34 when holding the battery cell 34. A sealing ring 90 is disposed about an inner surface of the collar 86 to seal an interface between the battery cell 34 and the collar 86.

Each of the collars 86 is disposed about a respective vent chamber opening 94 in the floor 88. The vent chamber openings 94 open to the vent chamber 62. Should a battery cell 34 undergo a thermal event and begin to expel vent byproducts through the side 46 of the cell 34, the vent byproducts can move from the battery cell 34 through the vent chamber opening 94 into an interior of the vent chamber 62. From the vent chamber 62, an outlet 96 can communicate the vent byproducts to an area outside the battery pack 14.

The cell holders 78 support the battery cells 34 at the axial end portions of the battery cells 34 having the sides 46. To support the opposite axial ends of the battery cells 34 in the first group 54, a plurality of pins 98 extend from the first housing 66. To support the opposite axial ends of the battery cells 34 in the second group 58, the pins 98 can extend from the second housing 70. The battery cells 34 are supported by the pins 98 on one axial end and by the collars 86 at opposite, second axial ends.

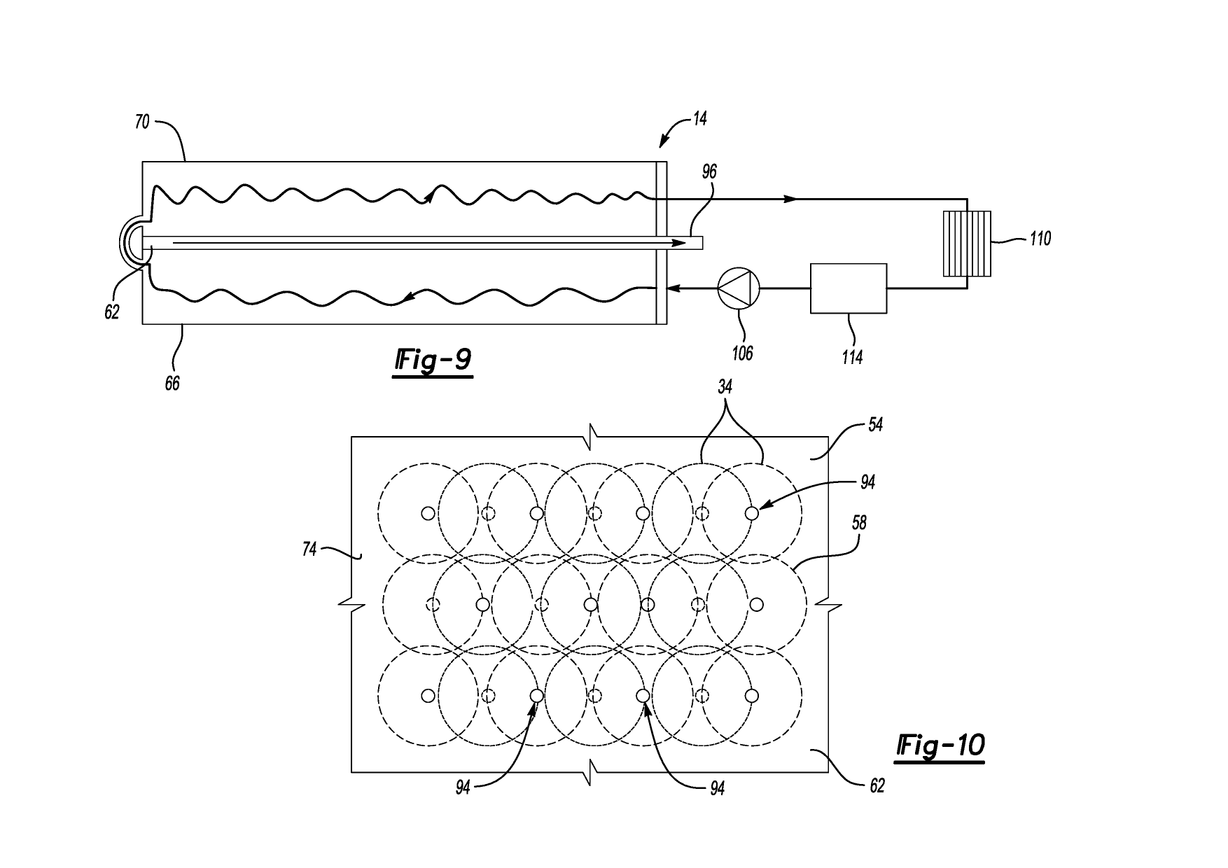

With reference now to FIG. 9 and continuing reference to FIGS. 2-8, the example battery pack 14 manages thermal energy of the battery cells 34 and other components of the battery pack 14 using a liquid. The cells 34 and other components of the battery pack 14 are at least partially immersed in the liquid. Thermal energy within the battery pack 14 is thus managed using an immersion thermal management system.

In this example, the liquid cools the battery cells 34 and the other components of the battery pack 14. In another example, the liquid could instead or additionally be used to heat the battery cells 34 and the other components. The liquid can be a dielectric coolant, for example.

In this example, a pump 106 circulates the liquid through the first housing 66 and the second housing 70 of the battery pack 14. The liquid is routed about the vent chamber 62 and is blocked from entering the vent chamber 62 through the vent chamber openings 94.

Within the first housing 66 and the second housing 70, the liquid moves over the battery cells 34 and other components and takes on thermal energy from the battery cells 34 and the other components. The liquid then moves from the battery pack 14 to a thermal exchange device 110. Thermal energy can be transferred away from the liquid at the thermal exchange device 110.

From the thermal exchange device 110, the liquid moves to a liquid supply 114. The liquid is drawn from the liquid supply 114, as required, and circulated by the pump 106 back to the battery pack 14.

Within the battery pack 14, the liquid is confined within the first housing 66 and the second housing 70. The sealing rings 90 block movement of liquid through the vent chamber openings 94 into the vent chamber 62.

The pins 98 and collars 86 support the battery cells 34 in positions where the battery cells 34 are spaced a distance from each other to provide gaps between the cells 34. The liquid can flow through these gaps when moving through the first housing 66 and the second housing 70.

With reference to the schematic view of FIG. 10 and continuing reference to FIGS. 2-9, the vent chamber openings 94 on the first side 74 of the vent chamber 62 are misaligned or staggered from the vent chamber openings 94 on the second side 82 of the vent chamber 62. Thus, when the cells 34 are aligned with the respective vent chamber openings 94, the cells 34 in the first group 54 are offset from the second group 58 of battery cells 34. The offset is relative to a direction that vent byproducts move through the vent chamber openings 94 into the vent chamber 62.

Misaligning the vent chamber openings 94 on the first side 74 from the vent chamber openings 94 on the second side 82 ensures that vent byproducts moving through one of the vent chamber openings 94 on the first side 74 or the second side 82 are not positioned to impinge directly upon one of the vent chamber openings 94 on the other of the first side 74 or the second side 82. Vent byproducts impinging directly on one of the vent chamber openings 94 could lead to vent byproducts moving through that vent chamber opening 94 near to one of the battery cells 34 that is not venting, which could cause the thermal event to cascade to that battery cell 34.

Features of the disclosed examples include battery cells immersed in a liquid to facilitate thermal energy transfer without comingling the liquid with areas of the battery pack receiving vent byproducts. The liquid can directly contact at least three sides of the battery cells. A gas-liquid separator may not be required to separate vent byproducts from the liquid because the vent byproducts do not mix with the liquid.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack venting system, comprising:
a first group of battery cells;
a second group of battery cells; and
a vent chamber sandwiched between a first group of battery cells and the second group of battery cells, the first group of battery cells and the second group of battery cells each configured to vent to the vent chamber.

2. The venting system of claim 1, wherein the first group of battery cells and the second group of battery cells are immersed in a liquid.

3. The venting system of claim 1, wherein the first group of battery cells and the second group of battery cells are immersion cooled.

4. The venting system of claim 1, wherein the first group of battery cells and the second group of battery cells are cylindrical battery cells.

5. The venting system of claim 1, wherein the first group of battery cells is inverted relative to the second group of battery cells.

6. The venting system of claim 1, wherein the vent chamber is sealed from a first housing that encloses the first group of battery cells, and from a second housing that encloses the second group of battery cells such that liquid communicated through the first housing and the second housing as part of an immersion thermal management system is blocked from entering the vent chamber.

7. The venting system of claim 1, wherein the battery cells in the first group of battery cells and within the second group of battery cells are each disposed along a respective battery cell axis, wherein each of the battery cell axes within the first group is offset from each of the battery cell axes within the second group.

8. The venting system of claim 1, further comprising a thermal management system having a liquid, the thermal management system configured to circulate the liquid between a first housing that encloses the first group of battery cells and through a second housing that encloses the second group of battery cells without the liquid passing through the vent chamber.

9. The venting system of claim 8, wherein the first group of battery cells and the second group of battery cells are at least partially immersed within the liquid.

10. The venting system of claim 1, further comprising a plurality of cell holders, the cell holders each configured to hold one of the battery cells within the first group of battery cells or one of the battery cells within the second group of battery cells.

11. The venting system of claim 10, wherein the cell holders are annular.

12. The venting system of claim 10, wherein the cell holders include a sealing ring configured to seal an interface between the respective cell holder and the respective battery cell.

13. The venting system of claim 10, wherein the cell holders extend from a side of the vent chamber.

14. The venting system of claim 10, wherein the first group of battery cells and the second group of battery cells are each configured to vent through a respective floor of a cell holder to the vent chamber.

15. The venting system of claim 1, further comprising a plurality of pins that interface with an end portion of a respective battery cell to hold a position of the respective battery cell.

16. The venting system of claim 15, wherein the pins are configured to hold the respective battery cell at a position spaced from an adjacent battery cells to provide a path for a liquid to flow.

17. A traction battery pack venting system, comprising:
a vent chamber of a battery pack;
a first housing of the battery pack, the first housing enclosing a first group of battery cells that are configured to vent into the vent chamber through a first side of the vent chamber;
a second housing of the battery pack, the second housing enclosing a second group of battery cells that are configured to vent into the vent chamber through a different second side of the vent chamber; and
a thermal management system having a liquid, the thermal management system configured to circulate the liquid through the first housing and the second housing.

18. The venting system of claim 17, wherein the first side is opposite the second side.

19. The venting system of claim 17, wherein the thermal management system circulates the liquid through the battery pack without the liquid passing through the vent chamber.
